(19) United States
(12) Patent Application Publication
(10) Pub. No.: US 2019/0063237 A1
(43) Pub. Date: Feb. 28, 2019

(54) LOCKING SPACER ASSEMBLY

(71) Applicant: Siemens Aktiengesellschaft, Munchen (DE)

(72) Inventors: Krishna C. Veluru, Indian Land, SC (US); Grzegorz Blaszczak, Charlotte, NC (US)

(21) Appl. No.: 16/059,421

(22) Filed: Aug. 9, 2018

Related U.S. Application Data
(60) Provisional application No. 62/549,633, filed on Aug. 24, 2017.

(51) Int. Cl. F01D 5/32; F01D 5/30

(52) U.S. Cl. CPC F01D 5/32; F01D 5/303; F04D 29/322; F05D 2260/30; F05D 2230/64

(57) ABSTRACT

A locking spacer assembly for filling a final spacer slot in a disk groove between platforms of adjacent blades of a blade assembly, a blade assembly and a method for installing a locking spacer assembly into a final spacer slot in a disk groove between platforms of adjacent blades of a blade assembly are presented. The locking spacer assembly includes a first end piece, a second end piece, and a mid spacer inserted between the first and second end pieces. The first and second end pieces include tabs respectively. The mid spacer includes clips. The locking spacer assembly is installed into the final spacer slot in the disk groove by snap locking engagements between the clips of the mid spacer with tabs of the first and second end pieces respectively.

### TECHNICAL FIELD

This invention relates generally to a locking spacer assembly, in particular, a locking spacer assembly configured to fill a final spacer slot in a disk groove between platforms of adjacent blades of a blade assembly in an industrial gas turbine engine.

### DESCRIPTION OF RELATED ART

An industrial gas turbine engine typically include a compressor for compressing air, a combustor for mixing the compressed air with fuel and igniting the mixture, a turbine section for producing mechanical power, and a generator for converting the mechanical power to an electrical power. The compressor and the turbine section include a plurality of blades that are attached on a rotor. The blades are arranged in rows axially spaced apart along the rotor and circumferentially attached to a periphery of a rotor disk.

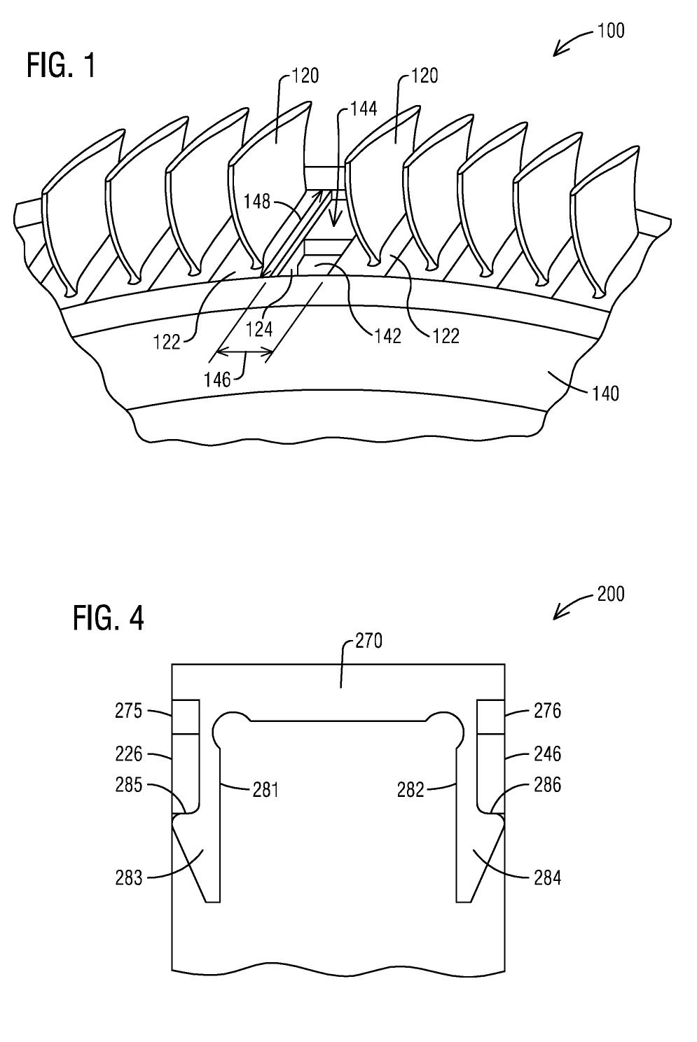

FIG. 1 illustrates a schematic perspective view of a portion of a blade assembly 100. As illustrated in FIG. 1, the blade assembly 100 includes a plurality of blades 120 that are attached to a rotor disk 140. Each blade 120 includes a platform 122 and a root 124 extending radially inward from the platform 122. During blade assembly, the blades 120 may be installed to the rotor disk 140 by inserting the roots 124 of the blades 120 into a disk groove 142 one at a time. The blades 120 then may be rotated until the roots 124 of the blade 120 engage the disk groove 142. Once all of the blades 120 are installed into the rotor disk 140, a final spacer slot 144 is remained in the disk groove 142 between the platforms 122 of adjacent blades 120. The final spacer slot 144 may not be filled with the blade 120 because there is not sufficient space for insertion and rotation. A locking spacer assembly is typically inserted into the final spacer slot 144 to lock the blades 120 to the rotor disk 140.

A conventional locking spacer assembly typically includes a plurality of pieces, such as side pieces, middle piece, bolt and nut. The conventional locking spacer assembly may experience uncertainties during assembly. For example, positive clamping may be needed to reduce dynamic loads transferred to the bolted joint. However, maintaining positive clamping may result in higher bearing stresses and limits available operating temperature range for joint material. Additionally, manufacture cost of the conventional locking spacer assembly may be high. There is a need to provide a simple, reliable and low cost locking spacer assembly.

### SUMMARY OF INVENTION

Briefly described, aspects of the present invention relate to a locking spacer assembly, in particular, a locking spacer assembly configured to fill a final spacer slot in a disk groove between platforms of adjacent blades of a blade assembly in an industrial gas turbine engine.

According to an aspect, a locking spacer assembly configured to fill a final spacer slot in a disk groove between platforms of adjacent blades of a blade assembly is presented. The locking spacer assembly comprises a first end piece comprising a top surface, a circumferential inner surface, a circumferential outer surface, an axial fore side surface, and an axial aft side surface. The locking spacer assembly comprises a second end piece comprising a top surface, a circumferential inner surface, a circumferential outer surface, an axial fore side surface, and an axial aft side surface. The locking spacer assembly comprises a mid spacer configured to be inserted between the circumferential inner surface of the first end piece and the circumferential inner surface of the second end piece. The first end piece comprises a tab on the axial fore side surface extending axially outwardly from the circumferential inner surface. The second end piece comprises a tab on the axial aft side surface extending axially outwardly from the circumferential inner surface. The mid spacer comprises a platform and a first leg and a second leg extending radially downwardly from bottom of the platform. The first leg comprises a first clip having a tapered shape tapping from a first land surface downwardly to end of the first leg. The second leg comprises a second clip having a tapered shape tapping from a second land surface downwardly to end of second first leg. The first land surface of the first clip is configured to snap with bottom of the tab of the first end piece. The second land surface of the second clip is configured to snap with bottom of the tab of the second end piece.

According to an aspect, a blade assembly is presented. The blade assembly comprises a rotor disk comprising a disk groove. The blade assembly comprises a plurality of blades inserted in the disk groove. Each of the blades comprises a platform. A final spacer slot is formed in the disk groove between platforms of adjacent blades. The blade assembly comprises a locking spacer assembly configured to fill the final spacer slot. The locking spacer assembly comprises a first end piece comprising a top surface, a circumferential inner surface, a circumferential outer surface, an axial fore side surface, and an axial aft side surface. The locking spacer assembly comprises a second end piece comprising a top surface, a circumferential inner surface, a circumferential outer surface, an axial fore side surface, and an axial aft side surface. The locking spacer assembly comprises a mid spacer configured to be inserted between the circumferential inner surface of the first end piece and the circumferential inner surface of the second end piece. The first end piece comprises a tab on the axial fore side surface extending axially outwardly from the circumferential inner surface. The second end piece comprises a tab on the axial aft side surface extending axially outwardly from the circumferential inner surface. The mid spacer comprises a platform and a first leg and a second leg extending radially downwardly from bottom of the platform. The first leg comprises a first clip having a tapered shape tapping from a first land surface downwardly to end of the first leg. The second leg comprises a second clip having a tapered shape tapping from a second land surface downwardly to end of second first leg. The first land surface of the first clip is configured to snap with bottom of the tab of the first end piece. The second land surface of the second clip is configured to snap with bottom of the tab of the second end piece.

According to an aspect, a method for installing a locking spacer assembly into a final spacer slot in a disk groove between platforms of adjacent blades of a blade assembly is presented. The locking spacer assembly comprises a first end piece, a second end piece and a mid spacer. The method comprises inserting the first end piece and the second end piece into the final spacer slot. The first end piece comprises a top surface, a circumferential inner surface, a circumferential outer surface, an axial fore side surface, and an axial aft side surface. The second end piece comprises a top surface, a circumferential inner surface, a circumferential outer surface, an axial fore side surface, and an axial aft side surface. The method comprises inserting the mid spacer into the final spacer slot between the circumferential inner surface of the first end piece and the circumferential inner surface of the second end piece. The first end piece comprises a tab on the axial fore side surface extending axially outwardly from the circumferential inner surface. The second end piece comprises a tab on the axial aft side surface extending axially outwardly from the circumferential inner surface. The mid spacer comprises a platform and a first leg and a second leg extending radially downwardly from bottom of the platform. The first leg comprises a first clip having a tapered shape tapping from a first land surface downwardly to end of the first leg. The second leg comprises a second clip having a tapered shape tapping from a second land surface downwardly to end of second first leg. The first land surface of the first clip is configured to snap with bottom of the tab of the first end piece. The second land surface of the second clip is configured to snap with bottom of the tab of the second end piece.

Various aspects and embodiments of the application as described above and hereinafter may not only be used in the combinations explicitly described, but also in other combinations. Modifications will occur to the skilled person upon reading and understanding of the description.

### DETAILED DESCRIPTION OF INVENTION

Exemplary embodiments of the application are explained in further detail with respect to the accompanying drawings. In the drawings.

FIG. 1 illustrates a schematic perspective view of a portion of a blade assembly showing a final spacer slot, wherein an embodiment of the inventive locking spacer assembly may be incorporated;

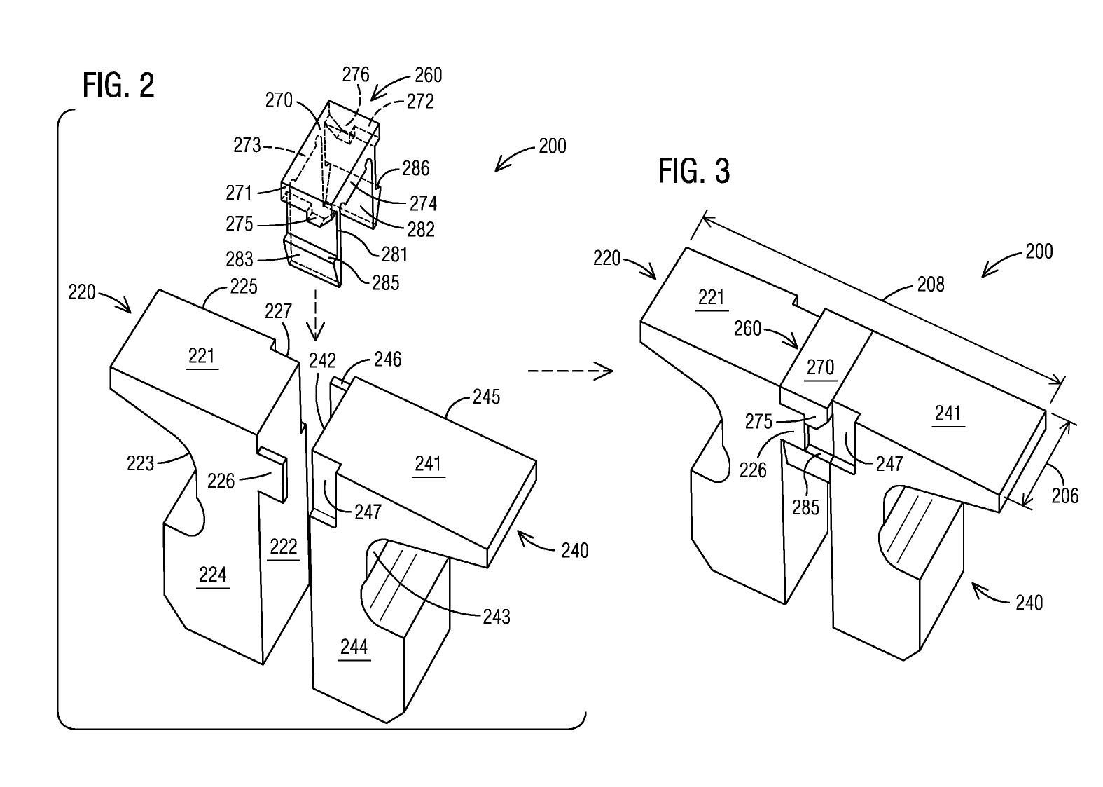

FIG. 2 illustrates a schematic exploded perspective view of a locking spacer assembly according to an embodiment of the invention;

FIG. 3 illustrates a schematic assembled perspective view of a locking spacer assembly according to an embodiment of the invention;

FIG. 4 illustrates a schematic side view of a portion of a locking spacer assembly according to an embodiment of the invention;

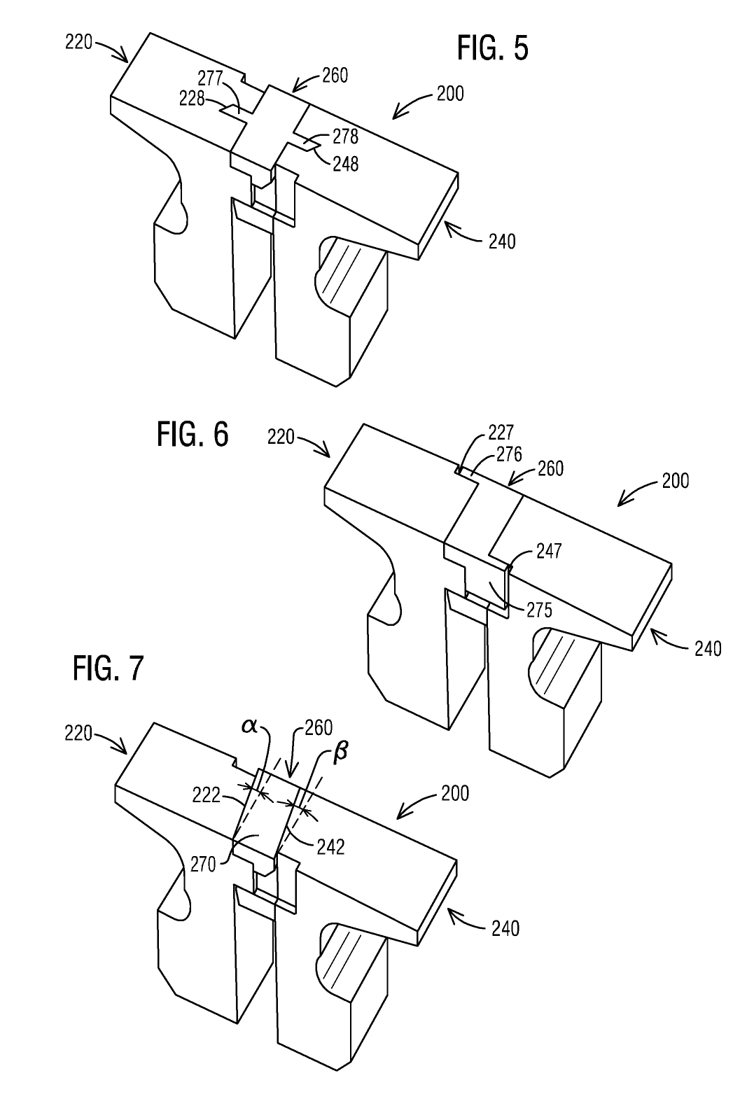

FIGS. 5-7 illustrates schematic assembled perspective views of a locking spacer assembly according to various embodiments of the invention; and

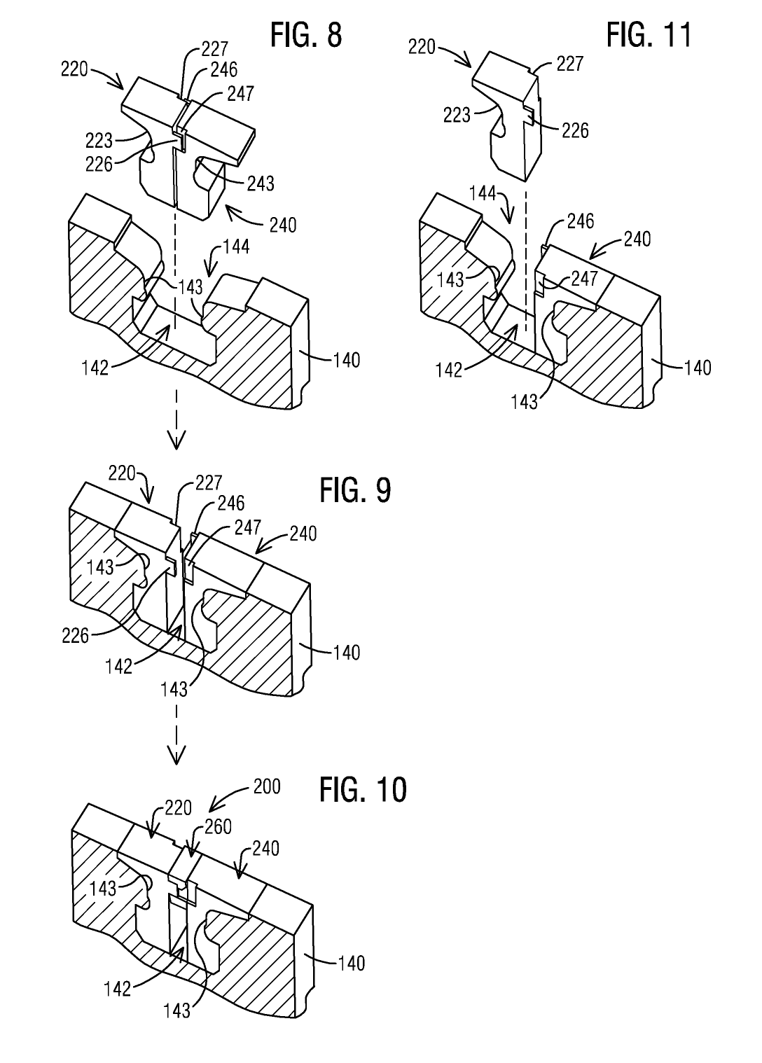

FIGS. 8-11 illustrate schematic sequential assembly perspective views of a locking spacer assembly according to an embodiment of the invention.

To facilitate understanding, identical reference numerals have been used, where possible, to designate identical elements that are common to the figures.

### DETAILED DESCRIPTION OF INVENTION

A detailed description related to aspects of the present invention is described hereafter with respect to the accompanying figures.

FIG. 1 illustrates a schematic perspective view of a portion of a blade assembly 100 showing a final spacer slot 144 in a disk groove 142 between platforms 122 of adjacent blades 120. The final spacer slot 144 may have a circumferential width 146 and an axial length 148. The blade assembly 100 may be a compressor blade assembly or a turbine blade assembly. The final spacer slot 144 may be filled by inventive embodiments of a locking spacer assembly 200 as shown in FIGS. 2-10, which are described in more detail below. The locking spacer assembly 200 may be installed into the final spacer slot 144 in the disk groove 142 during assembly of the blades 120 to the rotor disk 140. The locking spacer assembly 200 may be removed from the final spacer slot 144 in the disk groove 142 during disassembly of the blades 120 from the rotor disk 140.

FIG. 2 illustrates a schematic exploded perspective view of a locking spacer assembly 200 according to an embodiment of the invention. With reference to FIG. 2, the locking spacer assembly 200 may include a first end piece 220, a second end piece 240, and a mid spacer 260. The first end piece 220 may include a top surface 221, a circumferential inner surface 222, a circumferential outer surface 223, an axial fore side surface 224, and an axial aft side surface 225. The second end piece 240 may include a top surface 241, a circumferential inner surface 242, a circumferential outer surface 243, an axial fore side surface 244, and an axial aft side surface 245. The mid spacer 260 may be inserted between the circumferential inner surface 222 of the first end piece 220 and the circumferential inner surface 242 of the second end piece 240. The outer surface 223 of the first end piece 220 and the outer surface 243 of the second end piece 240 may have a profile that is configured to mate with a profile of a surface 143 of a disk groove 142 such that the outer surface 223 of the first end piece 220 and the outer surface 243 of the second end piece 240 may contact the surface 143 of the disk groove 142 after installed into the disk groove 142, as shown in FIGS. 7-10.

The first end piece 220 may include a tab 226 on the axial fore side surface 224. The tab 226 may extend axially outwardly from the circumferential inner surface 222. The first end piece 220 may include a recess 227 on the axial aft side surface 225. The recess 227 may be formed at an edge between the axial aft side surface 225 and the circumferential inner surface 222. The recess 227 extends radially downwardly from the top surface 221.

The second end piece 240 may include a tab 246 on the axial aft side surface 245. The tab 246 may extend axially outwardly from the circumferential inner surface 242. The second end piece 240 may include a recess 247 on the axial fore side surface 244. The recess 247 may be formed at an edge between the axial fore side surface 244 and the circumferential inner surface 242. The recess 247 extends radially downwardly from the top surface 241.

The mid spacer 260 may include a platform 270. The mid spacer 260 may include a first leg 281 and a second leg 282 that extend radially downwardly from bottom of the platform 270. The first leg 281 may include a first clip 283. The first clip 283 may have a tapered shape tapping from a first land surface 285 to the end of the first leg 281. The second leg 282 may include a second clip 284. The second clip 284 may have a tapered shape tapping from a second land surface 286 to the end of the second leg 282.

The platform 270 of the mid spacer 260 may include an axial fore side surface 271, an axial aft side surface 272, a first circumferential side surface 273, and a second circumferential side surface 274. The mid spacer 260 may include a fore side tab 275 on the axial fore side surface 271. The fore side tab 275 may extend radially downwardly from bottom of the platform 270. The fore side tab 275 may be located on the axial fore side surface 271 at edge with the second circumferential side surface 274. The mid spacer 260 may include an aft side tab 276 on the axial aft side surface 272. The aft side tab 276 may extend radially downwardly from bottom of the platform 270. The aft side tab 276 may be located on the axial aft side surface 272 at edge with the first circumferential side surface 273.

FIG. 3 illustrates a schematic assembled perspective view of the locking spacer assembly 200 as shown in FIG. 2. FIG. 4 illustrates a schematic side view of the locking spacer assembly 200 as shown in FIG. 3. As shown in FIG. 3 and FIG. 4, the mid spacer 260 may be inserted between the circumferential inner surface 222 of the first end piece 220 and the circumferential inner surface 242 of the second end piece 240 after assembly. The mid spacer 260 may be inserted from top of the first end piece 220 and the second end piece 240 with tools, such as a mallet or hydraulics. The fore side tab 275 may be radially engaged with the tab 226 of the first end piece 220. The aft side tab 276 may radially engage with the tab 246 of the second end piece 240. The top surface 221 of the first end piece 220, the top surface 241 of the second end piece 240, and the platform 270 of the mid spacer 260 may be aligned together forming a top surface of the locking spacer assembly 200. The locking spacer assembly 200 has a circumferential width 206 and an axial length 208 that correspond to a circumferential width 146 and an axial length 148 of a final spacer slot 144 in a disk groove 142, as shown in FIG. 1.

With reference to FIG. 3 and FIG. 4, the first land surface 285 of the first clip 283 of the first leg 281 may snap with bottom of the tab 226 of the first end piece 220. The second land surface 286 of the second clip 284 of the second leg 282 may snap with bottom of the tab 246 of the second end piece 240. The first clip 283 and the second clip 284 may function like a spring. The first clip 283 and the second clip 284 may lock the first end piece 220, the second end piece 240 and the mid spacer 260 together. The tab 226 and the tab 246 may hold the mid spacer 260 from falling out due to gravity while assembled. The tab 226 and the tab 246 may hold the mid space 260 from falling out due to centrifugal load during rotor disk 140 operation. The mid spacer 260 may restrict radially movement of the first end piece 220 and the second end piece 240. The mid spacer 260 may restrict axially movement of the first end piece 220 and the second end piece 240.

The recess 247 of the second end piece 240 may be cut from the top surface 241 to a radial location at least the same as or below than a radial location of bottom of the first tab 226 snapped with the first land surface 285 of the first clip 283. Snap engagement between the first clip 283 and the tab 226 of the first end piece 220 may be verified from the recess 247 of the second end piece 240. The recess 227 of the first end piece 220 may be cut from the top surface 221 to a radial location at least the same as or below than a radial location of bottom of the second tab 246 snapped with the second land surface 286 of the second clip 284. Snap engagement between the second clip 284 and the tab 246 of the second end piece 240 may be verified from the recess 227 of the first end piece 220.

The recess 227 and the recess 247 may form an access for tools to remove the mid spacer 260 out between the first end piece 220 and the second end piece 240. The first end piece 220 and the second end piece 240 may then be moved out of the final spacer slot 144. The lock spacer assembly 200 is disassembled from the final spacer slot 144.

FIG. 5 illustrates a schematic assembled perspective view of a locking spacer assembly 200 according to an embodiment of the invention. As illustrated in the exemplary embodiment of FIG. 5, the mid spacer 260 may include a first circumferential side tab 277 on the first circumferential side surface 273 extending axially outwardly. The first end piece 220 may include a slot 228 on the circumferential inner surface 222. The first circumferential side tab 277 may engage with the slot 228. The first circumferential side tab 277 may be located at a center of the first circumferential side surface 273. The mid spacer 260 may include a second circumferential side tab 278 on the second circumferential side surface 274 extending axially outwardly. The second end piece 240 may include a slot 248 on the circumferential inner surface 242. The second circumferential side tab 278 may engage with the slot 248. The second circumferential side tab 278 may be located at a center of the second circumferential side surface 274. The engagement of the first circumferential side tab 277 with the slot 228 of the first end piece 220 and the engagement of the second circumferential side tab 278 with the slot 248 of the second end piece 240 may prevent or restrict twisting of the first end piece 220 and the second end piece 240.

FIG. 6 illustrates a schematic assembled perspective view of a locking spacer assembly 200 according to an embodiment of the invention. As illustrated in the exemplary embodiment of FIG. 6, the fore side tab 275 of the mid spacer 260 may axially and radially extend out to fill the recess 247 of the second end piece 240. The aft side tab 276 of the mid spacer 260 may axially and radially extend out to fill the recess 227 of the first end piece 220. The mid spacer 260 may be removed out between the first end piece 220 and the second end piece 240 by drilling or cutting.

FIG. 7 illustrates a schematic assembled perspective view of a locking spacer assembly 200 according to an embodiment of the invention. As illustrated in the exemplary embodiment of FIG. 7, the circumferential inner surface 222 of the first end piece 220 may be orientated with an angle α with respect to a circumferential plane extending parallel to a circumferential direction of the locking spacer assembly 200. The circumferential inner surface 242 of the second end piece 240 may be orientated with an angle β with respect to a circumferential plane extending parallel to the circumferential direction of the locking spacer assembly 200. The orientation angle α of the circumferential inner surface 222 of the first end piece 220 may be the same as the orientation angle β of the circumferential inner surface 242 of the second end piece 240. The orientation angle α of the circumferential inner surface 222 of the first end piece 220 may be different from the orientation angle β of the circumferential inner surface 242 of the second end piece 240. The platform 270 of the mid spacer 260 may be configured to mate with the circumferential inner surface 222 of the first end piece 220 and the circumferential inner surface 242 of the second end piece 240.

FIGS. 8-11 illustrate schematic sequential assembly cross section perspective views of a locking spacer assembly 200 according to an embodiment of the invention. With reference to FIG. 8, the first end piece 220 and the second end piece 240 may be placed next to each other by the tab 226 of the first end piece 220 extending into the recess 247 of the second end piece 240 and the tab 246 of the second end piece 240 extending into the recess 227 of the first end piece 220. The first end piece 220 and the second end piece 240 may then be inserted into the final spacer slot 144 in the disk groove 142 of the rotor disk 140 together. With reference to FIG. 9, once the first end piece 220 and the second end piece 240 are inserted into the disk groove 142, the first end piece 220 and the second end piece 240 may then be spaced apart such that the outer surface 223 of the first end piece 220 and the outer surface 243 of the second end piece 240 are in contact with the surface 143 of the disk groove 142. With reference to FIG. 10, the mid spacer 260 may then be inserted between the first end piece 220 and the second end piece 240 from top of the first end piece 220 and the second end piece 240 with tools, such as a mallet or hydraulics.

FIG. 11 illustrates a schematic sequential assembly cross section perspective view of a locking spacer assembly 200 according to an alternative embodiment of the invention. Alternatively, the first end piece 220 and the second end piece 240 may be inserted into the final spacer slot 144 in the disk groove 142 one after. In the exemplary embodiment as shown in FIG. 11, the second end piece 240 may be firstly inserted into the final spacer 144 in the disk groove 142. The second end piece 240 may be moved to a side of the disk groove 142 such that a circumferential outer surface 243 is in contact with the surface 143 of the disk groove 142. The first end piece 220 may be secondly inserted into the final spacer 144 in the disk groove 142. The first end piece 220 may be moved to an opposite side of the disk groove 142 such that a circumferential outer surface 223 is in contact with the surface 143 of the disk groove 142, which is illustrated in FIG. 9. Similarly, the mid spacer 260 may then be inserted between the first end piece 220 and the second end piece 240 from top of the first end piece 220 and the second end piece 240 with tools, such as a mallet or hydraulics, as illustrated in FIG. 10. It is understood that the first end piece 220 may be firstly inserted into the final spacer 144 in the disk groove 142 and moved to a side of the disk groove 142. The second end piece 220 may be secondly inserted into the final spacer 144 in the disk groove 142 and moved to an opposite side of the disk groove 142.

According to an aspect, the proposed locking spacer assembly 200 eliminates using bolted joint in the locking spacer assembly 200 which may reduce additional stresses imposed on the locking spacer assembly 200. The proposed locking spacer assembly 200 may significantly reduce manufacturing cost.

According to an aspect, the proposed locking spacer assembly 200 includes snap locking engagement between a first clip 283 of a mid spacer 260 with a tab 226 of a first end piece 220 and a second clip 284 of the mid spacer 260 with a tab 246 of a second end piece 240. The snap locking engagement may reduce negative effects of contact reduction.

According to an aspect, the proposed locking spacer assembly 200 includes recess 227 and recess 247. The recess 227 and recess 247 may verify snap locking engagement between a first clip 283 of a mid spacer 260 with a tab 226 of a first end piece 220 and a second clip 284 of the mid spacer 260 with a tab 246 of a second end piece 240. The recess 227 and recess 247 may allow nondestructive disassembling of the locking spacer assembly 200.

Although various embodiments that incorporate the teachings of the present invention have been shown and described in detail herein, those skilled in the art can readily devise many other varied embodiments that still incorporate these teachings. The invention is not limited in its application to the exemplary embodiment details of construction and the arrangement of components set forth in the description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings.

### REFERENCE LIST

100: Blade Assembly
120: Blade
122: Platform of Blade
124: Root of Blade
140: Rotor Disk
142: Disk Groove
143: Surface of Disk Groove
144: Final Spacer Slot
146: Circumferential Width of Final Spacer Slot
148: Axial Length of Final Spacer Slot
200: Locking Spacer Assembly
206: Circumferential Width of Locking Spacer Assembly
208: Axial Length of Locking Spacer Assembly
220: First End Piece
221: Top Surface of the First End Piece
222: Circumferential Inner Surface of the First End Piece
223: Circumferential Outer Surface of the First End Piece
224: Axial Fore Side Surface of the First End Surface
225: Axial Aft Side Surface of the First End Surface
226: Tab of the First End Piece
227: Recess of the First End Piece
228: Slot of the First End Piece
240: Second End Piece
241: Top Surface of the Second Side Piece
242: Circumferential Inner Surface of the Second Side Piece
243: Circumferential Outer Surface of the Second Side Piece
244: Axial Fore Side Surface the Second Side Piece
245: Axial Aft Side Surface the Second Side Piece
246: Tab of the Second End Piece
247: Recess of the Second End Piece
248: Slot of the Second End Piece
260: Mid Spacer
270: Platform of the Mid Spacer
271: Axial Fore Side Surface of the Platform of the Mid Spacer
272: Axial Aft Side Surface of the Platform of the Mid Spacer
273: First Circumferential Side Surface of the Platform of the Mid Spacer
274: Second Circumferential Side Surface of the Platform of the Mid Spacer
275: Fore Side Tab of the Mid Spacer
276: Aft Side Tab of the Mid Spacer
277: First Circumferential Side Tab of the Mid Spacer
278: Second Circumferential Side Tab of the Mid Spacer
281: First Leg of the Mid Spacer
282: Second Leg of the Mid Spacer
283: First Clip
284: Second Clip
285: First Land Surface
286: Second Land Surface

What is claimed is:

1. A locking spacer assembly configured to fill a final spacer slot in a disk groove between platforms of adjacent blades of a blade assembly comprising:
a first end piece comprising a top surface, a circumferential inner surface, a circumferential outer surface, an axial fore side surface, and an axial aft side surface;
a second end piece comprising a top surface, a circumferential inner surface, a circumferential outer surface, an axial fore side surface, and an axial aft side surface; and
a mid spacer configured to be inserted between the circumferential inner surface of the first end piece and the circumferential inner surface of the second end piece,
wherein the first end piece comprises a tab on the axial fore side surface extending axially outwardly from the circumferential inner surface,
wherein the second end piece comprises a tab on the axial aft side surface extending axially outwardly from the circumferential inner surface,
wherein the mid spacer comprises a platform and a first leg and a second leg extending radially downwardly from bottom of the platform,
wherein the first leg comprises a first clip having a tapered shape tapping from a first land surface downwardly to end of the first leg,
wherein the second leg comprises a second clip having a tapered shape tapping from a second land surface downwardly to end of second first leg,
wherein the first land surface of the first clip is configured to snap with bottom of the tab of the first end piece, and
wherein the second land surface of the second clip is configured to snap with bottom of the tab of the second end piece.

2. The locking spacer assembly as claimed in claim 1,
wherein the first end piece comprises a recess on the axial aft side surface at edge with the circumferential inner surface extending radially downwardly from the top surface, and
wherein the recess is configured to check a snap engagement between the second clip and the tab of the second end piece.

3. The locking spacer assembly as claimed in claim 1,
wherein the second end piece comprises a recess on the axial fore side surface at edge with the circumferential inner surface extending radially downwardly from the top surface, and
wherein the recess is configured to check a snap engagement between the first clip and the tab of the first end piece.

4. The locking spacer assembly as claimed in claim 1,
wherein the mid spacer comprises a fore side tab on an axial fore side surface of the platform of the mid spacer extending radially downwardly from the bottom of the platform, and
wherein the fore side tab of the mid spacer is configured to radially engage with the tab of the first end piece.

5. The locking spacer assembly as claimed in claim 1,
wherein the mid spacer comprises an aft side tab on an axial aft side surface of the platform of the mid spacer extending radially downwardly from the bottom of the platform, and
wherein the aft side tab of the mid spacer is configured to radially engage with the tab of the second end piece.

6. The locking spacer assembly as claimed in claim 1,
wherein the mid spacer comprises a first circumferential side tab on a first circumferential side surface of the platform of the mid spacer extending axially outwardly, and
wherein the first circumferential side tab is configured to engage with a slot on the circumferential inner surface of the first end piece.

7. The locking spacer assembly as claimed in claim 1,
wherein the mid spacer comprises a second circumferential side tab on a second circumferential side surface of the platform of the mid spacer extending axially outwardly, and
wherein the second circumferential side tab is configured to engage with a slot on the circumferential inner surface of the second end piece.

8. A blade assembly comprising:
a rotor disk comprising a disk groove;
a plurality of blades inserted in the disk groove, wherein each of the blades comprises a platform, and wherein a final spacer slot is formed in the disk groove between platforms of adjacent blades; and
a locking spacer assembly configured to fill the final spacer slot,
wherein the locking spacer assembly comprises:
a first end piece comprising a top surface, a circumferential inner surface, a circumferential outer surface, an axial fore side surface, and an axial aft side surface;
a second end piece comprising a top surface, a circumferential inner surface, a circumferential outer surface, an axial fore side surface, and an axial aft side surface; and
a mid spacer configured to be inserted between the circumferential inner surface of the first end piece and the circumferential inner surface of the second end piece,
wherein the first end piece comprises a tab on the axial fore side surface extending axially outwardly from the circumferential inner surface,
wherein the second end piece comprises a tab on the axial aft side surface extending axially outwardly from the circumferential inner surface,
wherein the mid spacer comprises a platform and a first leg and a second leg extending radially downwardly from bottom of the platform,
wherein the first leg comprises a first clip having a tapered shape tapping from a first land surface downwardly to end of the first leg,
wherein the second leg comprises a second clip having a tapered shape tapping from a second land surface downwardly to end of second first leg,
wherein the first land surface of the first clip is configured to snap with bottom of the tab of the first end piece, and
wherein the second land surface of the second clip is configured to snap with bottom of the tab of the second end piece.

9. The blade assembly as claimed in claim 8,
wherein the first end piece comprises a recess on the axial aft side surface at edge with the circumferential inner surface extending radially downwardly from the top surface, and
wherein the recess is configured to check a snap engagement between the second clip and the tab of the second end piece.

10. The blade assembly as claimed in claim 8,
wherein the second end piece comprises a recess on the axial fore side surface at edge with the circumferential inner surface extending radially downwardly from the top surface, and
wherein the recess is configured to check a snap engagement between the first clip and the tab of the first end piece.

11. The blade assembly as claimed in claim 8,
wherein the mid spacer comprises a fore side tab on an axial fore side surface of the platform of the mid spacer extending radially downwardly from the bottom of the platform, and
wherein the fore side tab of the mid spacer is configured to radially engage with the tab of the first end piece.

12. The blade assembly as claimed in claim 8,
wherein the mid spacer comprises an aft side tab on an axial aft side surface of the platform of the mid spacer extending radially downwardly from the bottom of the platform, and
wherein the aft side tab of the mid spacer is configured to radially engage with the tab of the second end piece.

13. The blade assembly as claimed in claim 8,
wherein the mid spacer comprises a first circumferential side tab on a first circumferential side surface of the platform of the mid spacer extending axially outwardly, and
wherein the first circumferential side tab is configured to engage with a slot on the circumferential inner surface of the first end piece.

14. The blade assembly as claimed in claim 8,
wherein the mid spacer comprises a second circumferential side tab on a second circumferential side surface of the platform of the mid spacer extending axially outwardly, and
wherein the second circumferential side tab is configured to engage with a slot on the circumferential inner surface of the second end piece.

15. A method for installing a locking spacer assembly into a final spacer slot in a disk groove between platforms of adjacent blades of a blade assembly, wherein the locking spacer assembly comprises a first end piece, a second end piece and a mid spacer, the method comprising:
inserting the first end piece and the second end piece into the final spacer slot, wherein the first end piece comprises a top surface, a circumferential inner surface, a circumferential outer surface, an axial fore side surface, and an axial aft side surface, wherein the second end piece comprises a top surface, a circumferential inner surface, a circumferential outer surface, an axial fore side surface, and an axial aft side surface; and
inserting the mid spacer into the final spacer slot between the circumferential inner surface of the first end piece and the circumferential inner surface of the second end piece,
wherein the first end piece comprises a tab on the axial fore side surface extending axially outwardly from the circumferential inner surface,
wherein the second end piece comprises a tab on the axial aft side surface extending axially outwardly from the circumferential inner surface,
wherein the mid spacer comprises a platform and a first leg and a second leg extending radially downwardly from bottom of the platform,
wherein the first leg comprises a first clip having a tapered shape tapping from a first land surface downwardly to end of the first leg,
wherein the second leg comprises a second clip having a tapered shape tapping from a second land surface downwardly to end of second first leg,
wherein the first land surface of the first clip is configured to snap with bottom of the tab of the first end piece, and
wherein the second land surface of the second clip is configured to snap with bottom of the tab of the second end piece.

16. The method as claimed in claim 15,
wherein the first end piece comprises a recess on the axial aft side surface at edge with the circumferential inner surface extending radially downwardly from the top surface,
wherein the second end piece comprises a recess on the axial fore side surface at edge with the circumferential inner surface extending radially downwardly from the top surface, and
wherein the first end piece and the second end piece are inserted into the final spacer slot together by placing the first end piece and the second end piece next to each other with the tab of the first end piece extending into the recess of the second end piece and the tab of the second end piece extending into the recess of the first end piece.

17. The method as claimed in claim 16, further comprising:
checking a snap engagement between the second clip and the tab of the second end piece from the recess of the first end piece, and
checking a snap engagement between the first clip and the tab of the first end piece from the recess of the second end piece.

18. The method as claimed in claim 15,
wherein the first end piece and the second end piece are inserted into the final spacer slot one after another.

19. The method as claimed in claim 15,
wherein the mid spacer comprises a fore side tab on an axial fore side surface of the platform of the mid spacer extending radially downwardly from the bottom of the platform and an aft side tab on an axial aft side surface of the platform of the mid spacer extending radially downwardly from the bottom of the platform, and
wherein the fore side tab of the mid spacer is configured to radially engage with the tab of the first end piece and the aft side tab of the mid spacer is configured to radially engage with the tab of the second end piece.

20. The method as claimed in claim 15,
wherein the mid spacer comprises a first circumferential side tab on a first circumferential side surface of the platform of the mid spacer extending axially outwardly and a second circumferential side tab on a second circumferential side surface of the platform of the mid spacer extending axially outwardly, and
wherein the first circumferential side tab is configured to engage with a slot on the circumferential inner surface of the first end piece and the second circumferential side tab is configured to engage with a slot on the circumferential inner surface of the second end piece.
